(19) United States
(12) Patent Application Publication
(10) Pub. No.: US 2025/0186846 A1
(43) Pub. Date: Jun. 12, 2025

(54) CLUB RECOGNITION USING MARKERS

(71) Applicant: Rapsodo Pte. Ltd., Singapore (SG)

(72) Inventors: Ali Erol, Izmir (TR); Evgeny Lipunov, Singapore (SG); Samuel Whitcomb, Singapore (SG); Batuhan Okur, Singapore (SG)

(73) Assignee: Rapsodo Pte. Ltd., Singapore (SG)

(21) Appl. No.: 18/970,076

(22) Filed: Dec. 5, 2024

Related U.S. Application Data
(60) Provisional application No. 63/607,755, filed on Dec. 8, 2023.

(51) Int. Cl. A63B 60/42; A63B 102/32

(52) U.S. Cl. CPC A63B 60/42; A63B 2102/32; A63B 2220/807; A63B 2225/15

(57) ABSTRACT

Automatic club recognition during a golf swing is provided. At least one processor receives a series of images of a golf club captured during a golf swing. At least one processor detects from the series of images one or more sticker labels placed on the golf club. At least one processor classifies a golf club type of the golf club based on recognizing a marker, e.g., a unique or particular marker, coded on the one or more sticker labels, the marker for representing a specific type of golf club.

### CROSS-REFERENCE TO RELATED APPLICATIONS

This application claims the benefit of U.S. Provisional Application No. 63/607,755, filed on Dec. 8, 2023, which is incorporated by reference herein in its entirety.

### BACKGROUND

The present application relates generally to computers, computer applications, computer vision, image processing, and pattern recognition, and more particularly to club recognition such as golf club recognition using markers.

Using computer vision techniques, golf launching monitors may capture images or videos of golf swings or golf shots and provide automated performance evaluations to golfers. For example, golf launching results can be provided based on analyzing captured motion of golf club and golf ball during a golf swing. For analysis, which may use equipment parameters such as golf club parameters, challenges still exist in the ability to obtain those parameters.

### SUMMARY

The summary of the disclosure is given to aid understanding of a system and method of club recognition using markers, and not with an intent to limit the disclosure or the invention. It should be understood that various aspects and features of the disclosure may advantageously be used separately in some instances, or in combination with other aspects and features of the disclosure in other instances. Accordingly, variations and modifications may be made to the disclosed system and/or method.

A system, in some embodiments, includes at least one memory device. The system also includes at least one processor coupled with the memory device. The at least one processor is configured to receive a series of images of a golf club captured during a golf swing. The at least one processor is also configured to detect from the series of images, using a machine learning model, one or more sticker labels placed on the golf club. The at least one processor is also configured to classify, using the machine learning model, a golf club type of the golf club based on recognizing a marker coded on the one or more sticker labels, the marker for representing a specific type of golf club.

A computer-implemented method, in some embodiments, includes receiving a series of images of a golf club captured during a golf swing. The computer-implemented method also include detecting from the series of images, by a machine learning model, one or more sticker labels placed on the golf club. The computer-implemented method also include classifying, by the machine learning model, a golf club type of the golf club based on recognizing a marker coded on the one or more sticker labels, the marker for representing a specific type of golf club.

A system, in some embodiments, includes at least one memory device. The system also includes at least one processor coupled with the memory device, the at least one processor is configured to at least receive a series of images of a golf club captured during a golf swing. The at least one processor is also configured to detect from the series of images, one or more sticker labels placed on the golf club. The at least one processor is also configured to identify a type of the golf club based on recognizing a marker coded on the one or more sticker labels, the marker for representing a specific type of golf club, where the marker is coded with a pattern comprising two stripes and a gap separating the two stripes, each of the two stripes and the gap having a configured thickness, the type of the golf club being identified based on determining a cross-ratio using four image points defining thicknesses of the two stripes.

A computer readable storage medium storing a program of instructions executable by a machine to perform one or more methods described herein also may be provided.

Further features as well as the structure and operation of various embodiments are described in detail below with reference to the accompanying drawings. In the drawings, like reference numbers indicate identical or functionally similar elements.

### BRIEF DESCRIPTION OF THE DRAWINGS

FIG. 1 illustrates a golf swing environment including a mobile launch monitor (MLM) in an example embodiment.

FIGS. 2A-2D show images captured by a mobile launch monitor device in an example embodiment.

FIG. 3A is an example diagram showing a club head with stickers in some embodiments.

FIG. 3B is another example diagram showing a portion of a club shaft with stickers in some embodiments.

FIG. 4 shows sample labels for different types of clubs in some embodiments.

FIG. 5 is a diagram illustrating a method of club recognition using labels in some embodiments.

FIG. 6 shows data collection and training process of a machine learning model in some embodiments.

FIG. 7 shows a club type recognition process using a machine learning model in some embodiments.

FIG. 8 illustrates an example sticker configuration in some embodiments.

FIG. 9 shows a flow diagram illustrating an alternative method of club type recognition in some embodiments.

FIG. 10 shows a block diagram of a system that can perform club recognition in some embodiments.

FIG. 11 illustrates an example of configuring two stripes and a gap between the two stripes using bins or binning in some embodiments.

FIG. 12 shows an example of four image points used in calculating the cross ratio in some embodiments.

FIG. 13 shows another example of configuring two stripes and a gap between the two stripes using bins or binning in some embodiments.

### DETAILED DESCRIPTION

Systems and methods are disclosed for a passive and fully automated club recognition, for example, during a golf swing. For example, a system can automatically and passively (e.g., without an explicit user input) recognize the type of club being used during a golf swing, for example, in real time. The parameters of the recognized club can then be used for evaluating that golf swing by a launch monitor. In some embodiments, a passive fully automated club recognition technique is based on sticker markers placed on golf clubs such as the heads (also referred to as club heads) and/or shafts (also referred to as golf shafts) of the golf clubs. The system allows for a computer vision-based launch monitor to identify the club together with golf shot flight parameters for an error free evaluation of golfer's performance.

While the systems and methods described herein refers to golf clubs, and identifying golf club types, the systems and methods can also be applicable to other equipment, where a knowledge of equipment parameters are used in analyzing movements associated with such equipment.

Some analysis algorithms that evaluate performance of a golf shot use golf club parameters such as club head measurements. In such analysis algorithms, the performance evaluation of a golf shot depends on the golf club being used. For example, discarding information about the club type may not provide meaningful performance evaluation. For example, a launch angle of 25 degrees may correspond to a good shot for 9-iron club, but could be considered as a bad shot for a driver. Therefore, one might expect the user of a device such as a mobile launch monitor (MLM) to enter the club type manually, e.g., through an interface such as a mobile application's user interface, or by showing the club to the device to deliver a close-up picture or scan of the club. In both cases, it is expected that the user takes an action whenever the user changes the club before a swing. Omission on the part of the user of this action may lead to errors in performance evaluation. The system and method in some embodiments provide a completely passive, fully automatic technique to recognize the club being used, such that a launch monitor or like device employing analysis algorithm for evaluating performance, need not depend on a user manually inputting or showing the club information.

In some embodiments, the system employs computer vision techniques to identify the club being used. A computer-vision-based launch monitor captures the images of a golf shot. Predesigned markers in sticker format can be placed on the clubs, for example, on the head (club head) and/or the shaft (golf shaft) of a golf club to create unique or particular features on the captured images and help to identify the club type. Once the club type is identified, parameters or measurements such as club head measurements associated with that club type can be retrieved, for example, from a previously logged database. Those measurements can then be used in swing analysis.

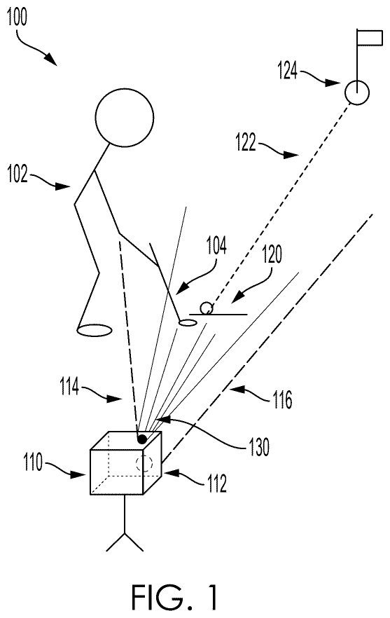

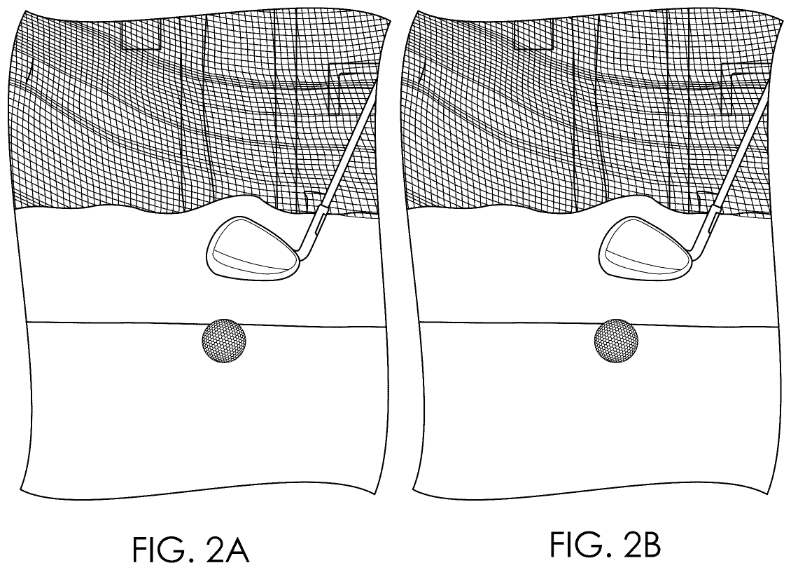

FIG. 1 illustrates a golf swing environment including a mobile launch monitor (MLM) in an example embodiment. The environment 100 includes a mobile launch monitor (MLM) 110 containing at least one camera 112 and an infrared light source 130 that are positioned and configured to capture images within a field of view, such as a field of view bound by a first line 114 and a second line 116. The light source 130 helps to eliminate the effects of varying illumination conditions of the environment. When the golfer 102 makes his/her shot, the camera 112 captures the images of the club 104 together with the golf ball 120 before and after the impact of the golf club striking the golf ball. The camera 112 also captures many images of the ball moving along a trajectory 122 toward a goal 124 for estimating the launch parameters. In some embodiments, only the first few images that capture the club face clearly at a close to vertical angle (e.g., as shown in FIGS. 2A-2D) may be used for club recognition purposes. FIGS. 2A-2D show example images of club heads, which can be captured by a camera or a launch monitor during a golf swing in some embodiments.

Mobile launch monitor (MLM) 110 (e.g., via the camera 112) captures images or video of user 102 swinging a club 104. The club 104 has one or more labels positioned on the club, for example, on the club head and/or club shaft. Label can be positioned on other locations where the MLM 110 can capture it during the user's swing. The label bears unique or particular identifier for each of the club type. The club type that the unique or particular identifier specifies includes the category of golf club and a number in that category. For example, categories of golf club can include wood including drivers, putters, irons, wedges, hybrids. A category can include a set of numbers. For instance, irons can be numbered ranging from 3-iron through 9-iron. In some embodiments, a unique or particular identifier can map to a club type of “7-iron”. Mobile launch monitor 110 need not require the user 102 to actively register the user's club 104 prior to the swing. Once the club is swung, the mobile launch monitor 110 recognizes the club type, in addition to the shot parameter estimation. For example, a camera coupled with the mobile launch monitor 110 captures the images of the club 104 with one or more labels (e.g., stickers with markers) and the mobile launch monitor 110 processes the one or more images to identify the club type automatically. In some embodiments, the sticker described here can be used independently of the mobile launch monitor 110 used and its placement. Hence, the sticker may also work for the mobile launch monitor device that is placed by the side of the user 102.

Mobile launch monitor (MLM) 110 may measure the motion properties such as launch speed, launch angle, spin rate, the trajectory, or the total carry of a golf ball after being hit by the golfer using the golf club. Golfers may also use these measurements to perfect their shots. In some aspects, a single shot might not represent the skills of the golfer reliably, and therefore multiple shot data is collected and analyzed statistically to report the golfer's current skill level. To be able to create meaningful reports, the shots should be analyzed in groups according to the types of the clubs used for the shots.

In some embodiments, recognition of clubs during a swing can be fully automated, based on using first few images of clubs captured during a golf swing (e.g., such as those shown in FIGS. 2A-2D) by placing special coded labels on the clubs. The special coded labels provide unique or particular identifiers for different club types.

FIGS. 2A-2D show images captured by a mobile launch monitor device in an example embodiment. A mobile launch monitor device uses the one or more images for shot parameter estimation. One or more stickers placed on a club (e.g., on the head and/or shaft) can be detected from the images and processed to determine a club type.

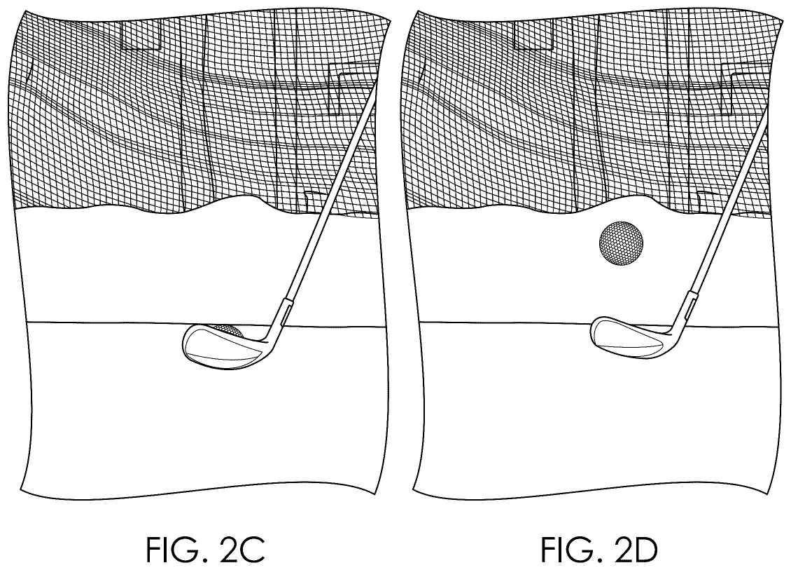

FIG. 3A is an example diagram showing a club head with a part of a sticker in some embodiments. A sticker 304, having unique or particular pattern 305 is positioned on a club 300. By way of example, sticker 304 is affixed on the rear face 301 of the club head. The shaft is denoted as 302, ball is denoted as 303. For instance, the images can be those captured before the head 301 of the club 300 hits the ball 303. The backside of the head has a sticker 304 with special symbols or unique or particular pattern 305 (unique identifier) coding the club type on it. The unique pattern 305 is specific to that particular kind of club.

FIG. 3B is another example diagram showing a portion of a club in some embodiments. In this example, a sticker or label is a ring such as a plastic ring. For instance, one or more plastic rings 306, 307 can be placed on the shaft 302 of a club 300. In some embodiments, the plastic rings may be an attachable ferrule. In another embodiment, a sticker having a unique identifier (e.g., marker) can be wrapped onto a ferrule on the club 300. For instance, FIG. 3B depicts a configuration in which the sticker or a plastic ring 306 or 307 is placed on the shaft 302 of the club 300. In some embodiments, the stickers and the rings can be combined depending on the club type to make the recognition easier. For some club types such as the driver, unique or particular code on a ring on the shaft may be easier to recognize than on a sticker on the head. In some embodiments, the sticker need not be fully wrapped around the circumference of the ferrule or the shaft.

In some embodiments, one unique identifier is used, which may be formed or printed on a sticker placed on the shaft or the club head. In some other embodiments, a combination of identifiers can be used, e.g., two stickers placed on the shaft. The combination can have the same or different patterns that are combined. In some embodiments, one or more identifiers can be placed on hosel of the club head, ferrule or both on the hosel and ferrule. In some embodiments, different combination of colors can be used as additional identifiers.

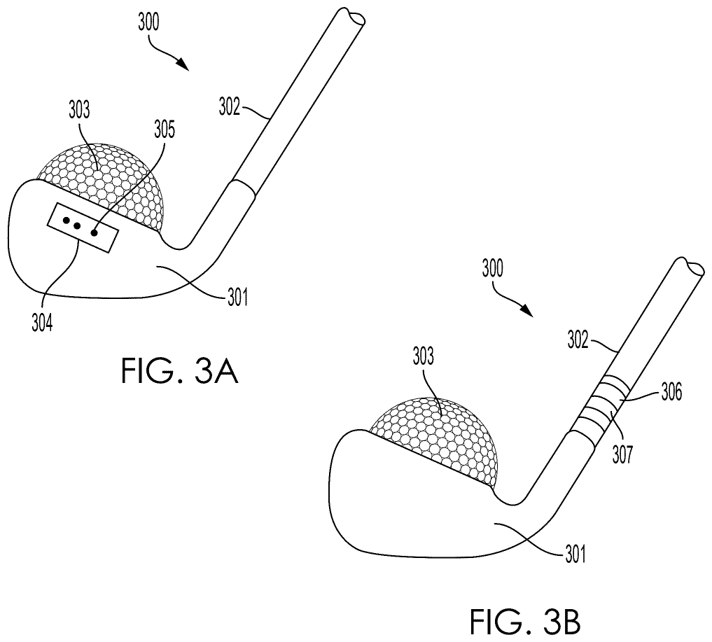

FIG. 4 shows sample labels for different types of clubs in some embodiments. For example, a label or sticker with a marker having a defined pattern 401, e.g., dot-dash-dot-dash-dot, can be used to uniquely identify a 7-iron club denoted as 7i. As another example, a sticker with a three ring pattern 402 can be designated as a unique identifier for a 7-iron club. Similarly, to identify a 5-wedge club denoted as 5w, a sticker with a marker pattern 403 as shown (e.g., dot-dash-dot) can be used as a unique identifier or particular identifier for that club type. As another example, a sticker with a two ring pattern 404 wrapped around the shaft of a club can be used to identify a 5-wedge club. Likewise, to identify a 6-iron club denoted as 6i, a sticker with a marker pattern 405 as shown (e.g., dot-dot-dot) can be used as a unique identifier or particular identifier for that club type. As another example, a sticker with one ring pattern 406 wrapped around the shaft of a club can be used to identify a 6-iron club. In this way, for example, each club type can be designated with a unique or particular identifier. FIG. 4 only shows examples of some marker patterns. Any marker pattern can be defined to represent a unique identifier for a club type. Once unique marker patterns are defined to represent respective club types, mapping of marker patterns to club types can be created and stored, for example, as a lookup table, in a database or another data storage. An image recognition technique can be employed to recognize a pattern on a club head or shaft from one or more club images (e.g., shown in FIGS. 2A-2D), and that recognized pattern can be looked up in a lookup table to determine the club type.

In some embodiments, the contents of the labels are designed such that they are easy to detect and classify using computer vision techniques. In some embodiments, to facilitate pattern recognition of objects in various lighting and illumination conditions of an environment in which computer vision is employed, the labels are designed to contain infra-red (IR) reflective markers to be illuminated by the light source 130 in FIG. 1. Other suitable reflective markers than the IR reflective markers can also be used. FIG. 4 depicts some examples of the labels. As an example, the sticker 401 and the ring 402 can be used in combination and this combination corresponds to 7i clubs. The combination of the sticker 403 and the ring 404 corresponds to 5w clubs. As an example, the flat stickers 401, 403 and 405 contain dots and lines. The stickers may contain only dots or only lines. The stickers may also contain other mark(s) than dots and lines. The marks can be configured such that they are specific for each golf club. When the marks comprise lines for example, the thickness of the lines or distance of the lines can be varied. As an example, rings are made up of stripes surrounding the whole shaft. Dots, lines, or stripes are considered to be easy features to detect to help fast detection and/or classification.

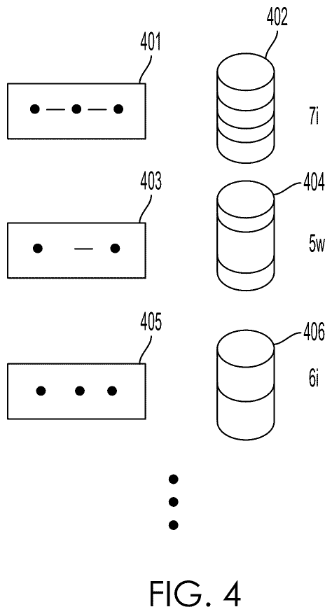

FIG. 5 is a diagram illustrating a method of cub recognition using labels in some embodiments. The method can be performed or run on one or more processors such as one or more computer processors, which can be part of a mobile launch monitor (e.g., shown at 110 in FIG. 1). Images captured of a golf club, e.g., during a golf swing, can be processed to recognize the club beings used. Given an image 502 showing the club, one or more labels in the image are detected at 504. For instance, one or more stickers and/or rings on the club (e.g., a bounding rectangle of a sticker or a ring shown in the image) are detected. The label detection 504 may also crop the content of the one or more bounding rectangles corresponding to the detected one or more labels. A cropped label contains content, a pattern that is the unique or particular identifier for the club. One or more cropped labels 506 are fed to label classification 508, which classifies the label into one of the golf club types 510. In some embodiments, the label detection 504 and/or the classification 508 processes can be implemented using conventional image processing and/or machine learning methods such as, but not limited to, extracting edge or blob-based features, and/or employing eigen values to feed into conventional classification engines. In some embodiments, the processing shown in FIG. 5, e.g., label detection 504 and label classification 508 employ machine learning models such as deep learning models for all stages of pattern recognition.

Generally, and for example, as described with reference to FIG. 5, after capturing the images of the club, the images can be processed to recognize the club beings used. In some embodiments, many images of clubs with stickers and rings having unique patterns are collected and labeled to train a deep learning model to perform the task of club recognition. In some embodiments, conventional image processing techniques can be used to target or detect symbols (patterns) or groups of symbols. Once labels are detected, they are cropped from the whole image and then processed to find the class of the corresponding label. Both conventional image processing methods targeting markers and deep learning-based classifiers may be employed.

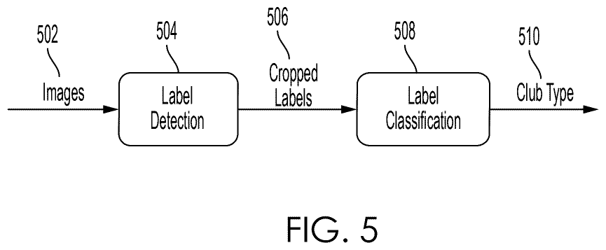

FIG. 6 shows in some embodiments data collection and training process of a machine learning model. An example of the machine learning model is a deep learning model. In some embodiments, the deep learning model has been trained to classify a given pattern into a club type. Developing a deep learning model includes a data collection and training process. At 602, stickers with unique or particular patterns are placed on golf clubs. For example, users with a variety of clubs may place stickers on their clubs. A unique or particular pattern maps to a club type. In some embodiments, for example, different patterns map to respective different club types. At 604, a device such as a mobile launch monitor captures the images of the clubs as the users perform their golf swings using the golf clubs having the stickers placed on them. At 606, the images captured for training are labeled, for example, manually, as ground truth labels, such that the labeled images can be used in a supervised machine leaning. For example, training data includes images of golf club heads and shafts, which have patterned stickers or rings placed on them, captured during golf swings. The collected images are labeled manually by drawing the bounding box of the labels in the images and specifying the club type. At 608, all the images, club type information and the labels are fed into deep learning models for training purposes. In some embodiments, data augmentation techniques, including rotation, translation, and brightness adjustments, are applied to increase the training data's diversity and robustness. In some embodiment, for example, in a cropping stage, the images are pre-processed to resize them to a consistent resolution. The output of the training process is an optimized deep learning model for detection and classification of a club in a single image. So, for example, at 610, by training, a deep learning model for recognizing arbitrary golf clubs with stickers is obtained. In some embodiments, the deep learning model is a Convolutional Neural Network (CNN) designed for marker detection and club type classification. The architecture of such CNN includes convolutional layers, pooling layers, and fully connected layers. In some embodiments, a pre-trained CNN architecture can be utilized as a starting point of training. In some embodiments, customized layers can be added or implemented in the CNN for marker detection. In some embodiments, activation functions such as a rectified linear unit (ReLU) can be used for introducing non-linearity to the deep learning model or CNN. In some embodiments, softmax activation layer, e.g., as the last layer or output layer of the deep learning model, can be implemented for multi-class club type classification.

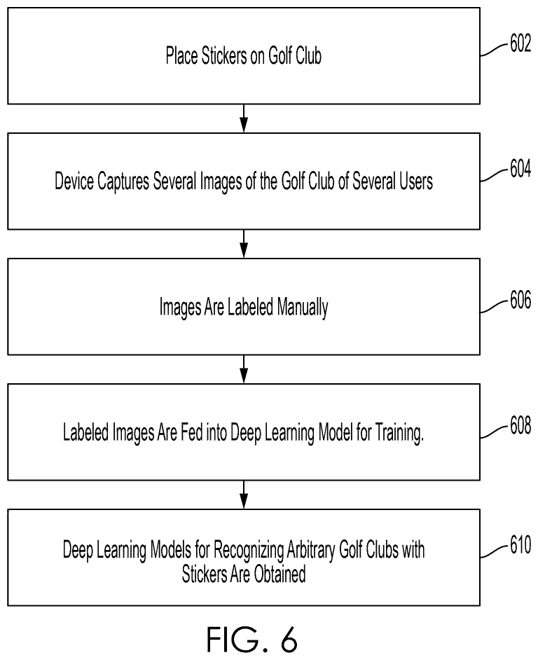

FIG. 7 shows a club type recognition process using a machine learning model in some embodiments. An example of the machine learning model is a deep learning model. Once the deep learning model is obtained or trained, for example, as described with reference to FIG. 6, the deep learning model is deployed. In some embodiments, the deep learning model is deployed to run on special devices. A special device can be a mobile launch monitor. In some embodiments, deployment may include a quantization of the model parameters to support special hardware for running the deep learning models. At 702, one or more stickers are placed on a golf club or golf clubs, for example, those that are being used in a golf swing. For example, a user, or any other individual, or machine may place a sticker on a golf club, for example, on a club head and/or a club shaft. At 704, a device such as a mobile launch monitor captures the images of the golf club and the ball, for example, during a swing. In some embodiments, for recognition purposes, only the images close to the impact time (short time before and after the impact) may be used. At 706, the captured images are fed into the deep learning model that is trained. For example, each of the captured images is fed or input into the deep learning model, for the deep learning model to classify a club type shown in that image. For the given input image, the deep learning model classifies club type. For example, at 708 the deep learning model classifies a club type for each input image. The deep learning model can also provide its confidence measure for that classification. Thus, in some embodiments, the deep learning model determines the club type and a confidence measure for each image. At 710, the club type classification result with maximum confidence measure can be chosen as the club type. In another aspect, the club type classification with the majority of the club type candidates can be taken as the final decision for the club type.

The following example materials may be used for labels or stickers placed on the clubs in some embodiments. For example, vinyl stickers may be used. Vinyl can be weatherproof, and is highly resistant to moisture, ultraviolet (UV) rays, and extreme temperatures. As another example, vinyl stickers with laminate may be used. Applying a clear laminate over vinyl stickers further enhances their weather resistance, making them even more durable. As yet another example, polyester stickers may be used. Polyester stickers are known for their resistance to water, chemicals, and UV exposure. They are suitable for outdoor use and can maintain their vibrant colors over time. Still yet as another example, polypropylene stickers may be used. Polypropylene stickers are tear-resistant, waterproof, and resistant to oils and chemicals. They can be a good choice for outdoor applications. As a further example, synthetic paper stickers may be used. Some synthetic paper materials are designed to be waterproof and durable. They offer a balance between paper-like appearance and weather resistance. As yet, another example, laminated stickers may be used. Adding a clear, weather-resistant laminate layer over the stickers may protect them from moisture, UV rays, and abrasion. This is a versatile option that can be applied to various sticker materials. As another example, UV-resistant inks or UV light resistant inks may be used, which may ensure that the inks used for printing the stickers are UV-resistant or UV light resistant to prevent fading and discoloration when exposed to sunlight. For example, sticker labels can be stickers with UV light resistant inks. Still yet as another example, permanent adhesives may be used, which are stickers with a strong and permanent adhesive that will bond well to various surfaces and resist peeling or falling off, even in wet conditions.

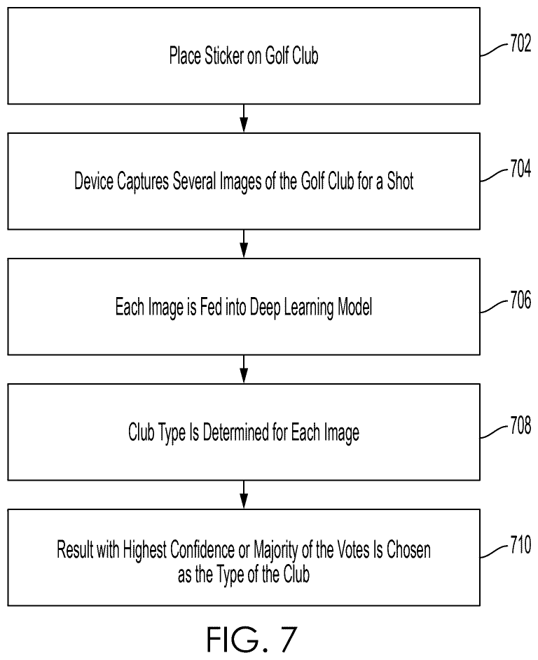

In some embodiments, stickers may also be heat-released or heat-releasable stickers, where the stickers may be easily removed from the golf club by applying heat, thereby not leaving any residue on the golf club. FIG. 8 illustrates an example sticker configuration in some embodiments. A configuration shown in FIG. 8 implements a heat-released sticker. For example, a base film 802 has a basic adhesive 804 layered on one side of its surface and a Thermal Release (TR) adhesive 806 layered on the other side of its surface. Polyethylene Terephthalate (PET) release liner 808 is layered on the basic adhesive 804. Another PET release liner 810 is layered on the TR adhesive 806. In some embodiments, unique pattern indicating club type may be printed on the base film 802. In some embodiments, stickers may have see-through background, allowing for the stickers to be more discrete. For instance, stickers may be see-through background stickers.

As described above, a system and/or method provides for fully passive determination of the golf club during a golf swing. For example, a user is not required to actively scan the club prior to the swing.

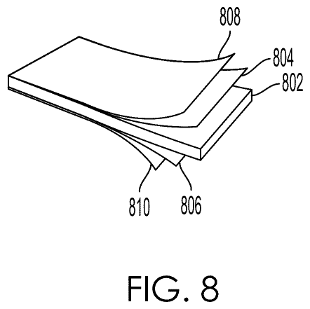

FIG. 9 shows another flow diagram illustrating a method of club type recognition in some embodiments. The method can be implemented and/or run on one or more hardware processors, or coupled with one or more hardware processors. One or more hardware processors, for example, may include components such as programmable logic devices, microcontrollers, memory devices, and/or other hardware components, which may be configured to perform respective tasks described in the present disclosure. Coupled memory devices may be configured to selectively store instructions executable by one or more hardware processors. In some embodiments, one or more hardware processors are incorporated into a mobile launch monitor (MLM). At 902, the method includes receiving a series of images of a golf club captured during a golf swing. In some embodiments, a Fast Fourier Transform (FFT) may be applied to the series of received images captured during the golf swing in step 902. At 904, the method includes detecting from the series of images, by a machine learning model such as a deep learning model, one or more sticker labels placed on the golf club. At 906, the method includes classifying, by the machine learning model, a golf club type of the golf club based on recognizing a marker, e.g., unique or particular marker, coded on the one or more sticker labels, the marker for representing a specific type of golf club. For example, the marker is a unique or particular pattern described above, which can be printed or coded on a sticker. Sticker labels are stickers described above. In some embodiments, as described herein, the machine learning model including the deep learning model is a trained machine learning model.

In some embodiments, the method also includes capturing using a camera the series of images of the golf club during the golf swing. In some embodiments, the method also includes, prior to using the machine learning model in the detecting and the classifying, training the machine learning model using as training data a plurality of images of golf clubs captured during a plurality of sessions of golf swings, to detect sticker labels placed on golf clubs and to classify golf club types based on recognizing markers, e.g., unique or particular markers, assigned to different types of golf clubs coded on the sticker labels. In some embodiments, as shown and described above, the one or more sticker labels are detected from one or more of the golf club's head and the golf club's shaft. In some embodiments, the unique marker includes a combination of symbols coded on the one or more sticker labels. In some embodiments, the one or more sticker labels include retro-reflective material. In some embodiments, retroreflective materials include fabrics having micro glass beads as a retroreflective element. In some embodiments, retroreflective materials include fabrics or paints. In some embodiments, the fabrics or paints are in the form of micro glass beads (such as in nanometer or micrometer size as a retroreflective element. In some embodiments, the glass beads may be in nanometer or micrometer size, nearly like a powder.

With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer storage medium or media includes one or more storage devices that collectively include machine readable code corresponding to instructions and/or data for performing computer operations specified in a given computer storage medium claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include, but are not limited to: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

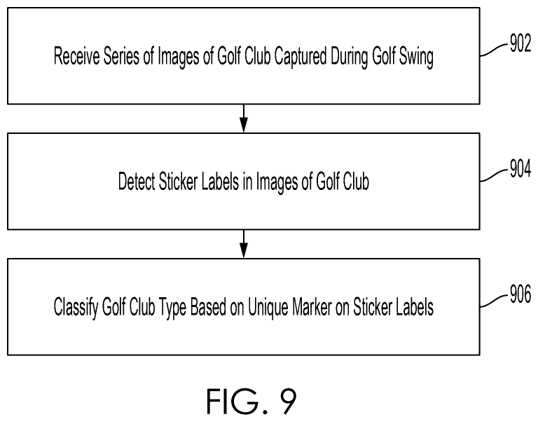

FIG. 10 shows a block diagram of a system in some embodiments that can perform club recognition described herein. The components of the system may be part of a mobile launch monitor (MLM), for example, shown in FIG. 1 at 110. One or more hardware processors 1002 such as a central processing unit (CPU), a graphic process unit (GPU), and/or a Field Programmable Gate Array (FPGA), an application specific integrated circuit (ASIC), and/or another processor, may be coupled with a memory device 1004, and perform club recognition, for example, using a deep learning model. The memory device 1004 may include random access memory (RAM), read-only memory (ROM) or another memory device, and may store data and/or processor instructions for implementing various functionalities associated with the methods and/or systems described herein. One or more hardware processors 1002 may execute computer instructions stored in memory device 1004 or received from another computer device or medium. The memory device 1004 may, for example, store instructions and/or data for functioning of one or more hardware processors 1002, and may include an operating system and other program of instructions and/or data. One or more hardware processors 1002 may receive a series of images of a golf club captured during a golf swing, detect from the series of images, e.g., using a machine learning model such as a deep learning model, one or more sticker labels placed on the golf club, classify, using the deep learning model, a golf club type of the golf club based on recognizing a unique marker coded on the one or more sticker labels, the unique marker for representing a specific type of golf club. The system may also include one or more cameras 1006 for capturing images, and one or more 1008 radars for detecting motion of one or more objects.

In some embodiments, a marker coded on one or more sticker labels includes a pattern that includes two stripes and a gap separating the two stripes, each of the two stripes and the gap having a configured thickness, the type of the golf club being identified based on determining a cross-ratio using four image points defining thicknesses of the two stripes.

In some embodiments, identifying a golf club type based on such markers that include a configuration of two stripes placed with a gap in-between the two stripes and using a cross-ratio need not use a machine learning model. For instance, a processor with at least one memory device may be configured to perform such identifying. For example, a processor may be configured to perform the following operations: receive a series of images of a golf club captured during a golf swing; detect from the series of images, one or more sticker labels placed on the golf club; and identify a type of the golf club based on recognizing a marker coded on the one or more sticker labels, the marker for representing a specific type of golf club, where the marker is coded with a pattern that has two stripes and a gap separating the two stripes, each of the two stripes and the gap having a configured thickness, the type of the golf club being identified based on determining a cross-ratio using four image points defining the thicknesses of the two lines stripes.

For example, a marker that includes two stripes can be placed on the shaft of the golf club. Such marker can be used independently or in combination with any of the markers placed on the club head described in other embodiments. The two stripes may be aligned parallel to one another (e.g., two parallel stripes or lines). In some embodiments, the two lines or stripes may be aligned parallel to one another and may be separated by a gap. The gap can be a distance between the two stripes aligned in parallel. In some embodiments, the two stripes may have same color (and e.g., same brightness) but different color and/or brightness with the gap. In some embodiments, two stripes may be wrapped around the shaft of the golf club in parallel.

In some embodiments, the thickness of the two stripes and the gap are configured based on dividing the two stripes and the gap into a specified number of bins. The pattern, which includes the two stripes and the gap therebetween, is formed based on the number of bins, into which the two stripes and the gap fall.

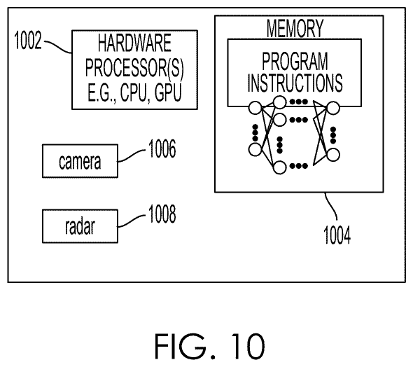

FIG. 11 illustrates an example of configuring two stripes and a gap between the two stripes using bins or binning to group the two stripes and the gap in some embodiments. One example shows one configuration of the two stripes and the gap layout, one stripe is positioned on the right and another stripe is positioned on the left spaced by a gap, and this configuration is grouped into eight bins 1102. In this configuration, the bins with “1”s represent the thickness of the stripes of the marker and the bins with “0”s represent the gap defined between the two stripes. For instance, the thickness unit is measured in terms of the number of bins. For example, referring to the row with “index 1” 1104, stripe (referred to as a first stripe for simplicity of explanation) has 1 bin thickness (indicated by one bin with “1” on the left), another stripe (referred to as a second stripe for simplicity of explanation) has 1 bin thickness (indicated by one bin with “1” on the right), and a gap between the first stripe and the second stripe has six bin thickness (indicated by six bins with “0”). By way of another example, referring to the row with “index 9” 1106, a first stripe has 4 bin thickness (indicated by four bins with “1” on the left), a second stripe has 2 bin thickness (indicated by two bins with “1” on the right), and a gap between the first stripe and the second stripe has two bin thickness. In practice, each bin can be configured with an actual length measure, e.g., a centimeter, a tenth of an inch, or another measurement unit.

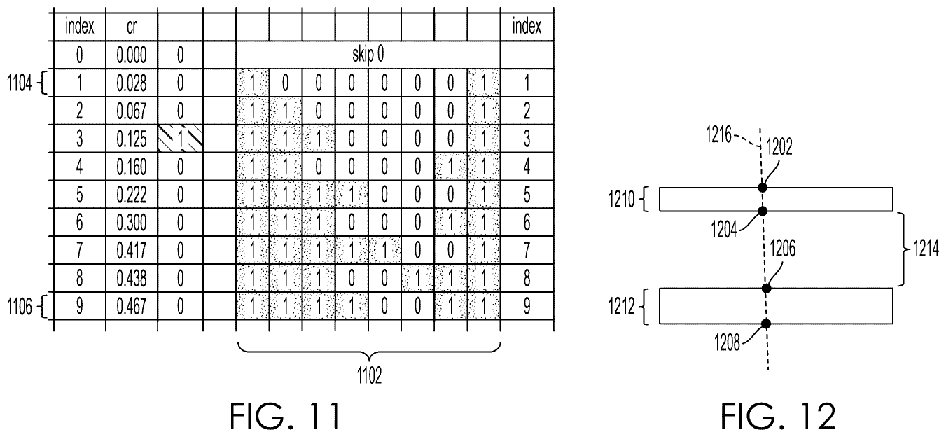

In some embodiments, indexing a unique marker pattern can be done using a cross-ratio technique. For example, a marker having a pattern of two stripes with a gap between the two stripes can be detected by a device (e.g., a processor or a computer processor) employing an imager or a camera. The device calculates a cross ratio using four image points (two pairs of image points) on the two stripes that define the thickness of the two stripes. FIG. 12 shows an example of four image points used in calculating the cross ratio. A pattern on a marker can include two stripes (a first stripe 1210 and a second stripe 1212) placed between a gap 1214. Four points 1202, 1204, 1206, 1208 lie in an imaginary projection line (shown as dotted/dashed line) 1316 that runs through the two stripes and the gap. Two points 1202, 1204 on two edges of first strip 1210 define the thickness of first stripe 1210. Similarly, two points 1206, 1208 on two edges of second stripe 1212 define the thickness of second stripe 1212. Points 1202 and 1206 can also be referred to as top edge points. Points 1204 and 1208 can be referred to as bottom edge points. For instance, if considering that two edges of a stripe 1210 define the thickness, the edge that point 1202 falls on can be considered a top edge, and the edge that point 1204 falls on can be considered a bottom edge. Similarly, if considering that two edges of a stripe 1212 define the thickness, the edge that point 1206 falls on can be considered a top edge, and the edge that point 1208 falls on can be considered a bottom edge. In some embodiments, the sticker label may be marked with bin units such that it can be detected which bin units the four points coincide. For example, using the configuration of 8 bins, each bin is given a numerical number from 0 to 8 starting with the bin position from left to right. Point 1202 may coincide with bin 0, point 1204 may coincide with bin 1, point 1206 may coincide with bin 7 and point 1208 may coincide with bin 8. In this case, cross ratio would be calculated for {0, 1, 7, 8}.

Briefly, the cross ratio is a number that describes the relationship between four points on a line, e.g., four collinear points. Cross ratio of (a,b; c,d) is defined as

$${λ}_{abcd} = \frac{( a - b ) * ( c - d )}{( b - c ) * ( a - d )} .$$

To provide a unique cross ratio, in some embodiments, the cross ratio is defined between (0 to 0.5). Regarding uniqueness of the cross ratio, if there is cross ratio λ_{abcd}=((a−b)*(c−d))/((b−c)*(a−d)) for {a, b, c, d}, then shuffling {a, b, c, d} to {b, a, c, d}, and so forth, with all possible combinations (in this instance, there are 6 possible combinations), will result in λ, 1−λ, 1/λ, 1/(1−λ), λ/(λ−1) and (λ−1)/λ. If λ is within [0, 1] then the rest would map to [1, 0], [+inf, 1], [1, +inf], [0, −inf], [−inf, 0], yet there still are two (not unique) λ and 1−λ which are in [0, 1]. To make λ unique, the technique disclosed herein, in some embodiments, maps cross ratio into [0, 0.5].

In some embodiments, the following cross ratio normalization function is provided. For example, for a cross ratio (“cr”), calculate normalized cross ratio to be within [0.0, 0.5] as follows: cr_nrm=if(cr<−1,1/(1−cr),if(cr<0,cr/(cr−1),if(cr<0.5,cr,if(cr<1,(1−cr),if(cr<2,(cr−1)/cr,1/cr))))). Note that this notation follows a nested if-then-else syntax, e.g., cr_nrm=if(cr<−1 then 1/(1−cr) else if(cr<0 then cr/(cr−1) else if(cr<0.5 then cr else if(cr<1 then (1−cr) else if(cr<2 then (cr−1)/cr else 1/cr))))). In the example shown in FIG. 11, cross ratios are transformed or normalized to {0.417, 0.300, 0.222, 0.160, 0.125, 0.067, 0.028} and the index are sorted {1,2,3, 4, 5, 6, 7, 9}->{9, 8, 7, 6, 5, 4, 3, 2, 1} so that cross ratios are arranged in ascending order {0.028, 0.067, 0.125, 0.417, 0.160, 0.222, 0.300, 0.438, 0.467} all within [0, 0.5] and unique. In some embodiments, the cross-ratio for each index (‘cr’ shown in FIG. 11) is normalized and mapped into [0, 0.5]. For instance, if for index #2, edges are at 0, 2, 7, 8, cross-ratio of {0, 2, 7, 8} is 0.067. Following this computation, the normalized cross ratios are then sorted, e.g., in ascending order.

Using the calculated cross ratio, a pre-built or pre-configured template can be looked up by the unique cross ratio, and determine an index mapped to that unique cross ratio. The index also maps to a golf club type. In this way, in some embodiments, a specific golf club type associated with the marker captured on the golf club in the image can be identified. For example, referring to FIG. 11, “index 1” is mapped to cross ratio value “0.028”. This index in turn can be mapped to a golf club type. By way of example, index #1 (“index 1”), which can be associated with golf club 5-iron (by way of example only), has 2 stripes (each with thickness of one bin) separated by a gap of 6 bins. As another example, index #2 (“index 2”), which can be associated with golf club 6-iron (by way of example only), has 2 stripes (thickness of one stripe is 2 bins, thickness of another stripe is 1 bin) separated by a gap of 5 bins.

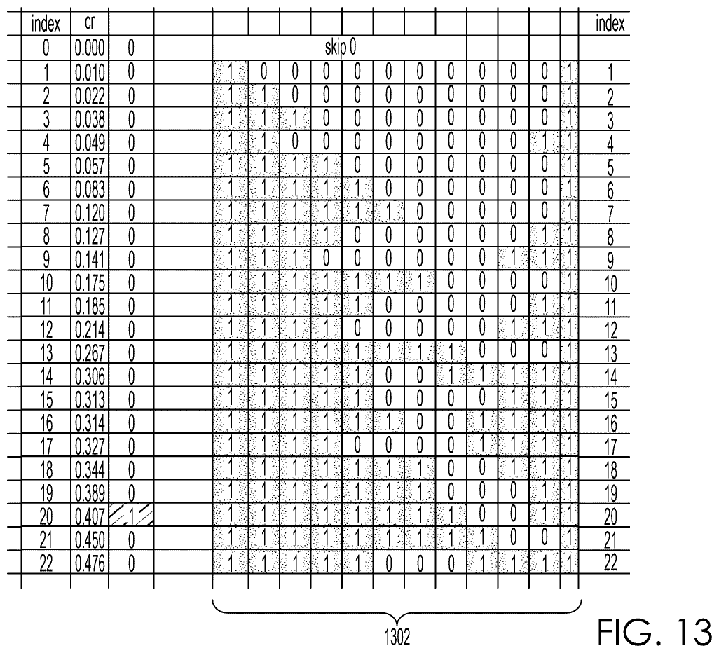

FIG. 13 shows another example of configuring two stripes and a gap between the two stripes using bins or binning in some embodiments. The example shows 12 bins 1302 with codes 1 to 22 (e.g., 22 indices). In some embodiments, other suitable bin numbers or binning can be used to define the thickness of the two stripes and the gap between the two stripes.

In some embodiments, a template can be created that maps cross-ratios and golf club types based on using combinations of thicknesses of the two stripes and the gap corresponding to respective golf club types, where the cross-ratio is matched with one of the cross-ratios specified in the template in identifying the golf club type.

In some embodiments, the patterns, for example, including those using bins with specific gaps and thickness can be registered in a database. Each pattern (which is unique) can be mapped with a golf club type. During the swing, a device recognizes or observes from the images captured, a pattern on the golf club (e.g., on the head and/or the shaft) which will then be matched with a pattern registered in the database. A golf club type that is mapped to the matched pattern is then identified as the type of the golf club in the captured images.

The terminology used herein is for the purpose of describing particular embodiments only and is not intended to be limiting of the invention. As used herein, the singular forms “a”, “an” and “the” are intended to include the plural forms as well, unless the context clearly indicates otherwise. As used herein, the term “or” is an inclusive operator and can mean “and/or”, unless the context explicitly or clearly indicates otherwise. It will be further understood that the terms “comprise”, “comprises”, “comprising”, “include”, “includes”, “including”, and/or “having,” when used herein, can specify the presence of stated features, integers, steps, operations, elements, and/or components, but do not preclude the presence or addition of one or more other features, integers, steps, operations, elements, components, and/or groups thereof. As used herein, the phrase “in some embodiments” does not necessarily refer to the same embodiment, although it may. As used herein, the phrase “in one embodiment” does not necessarily refer to the same embodiment, although it may. As used herein, the phrase “in another embodiment” does not necessarily refer to a different embodiment, although it may. Further, embodiments and/or components of embodiments can be freely combined with each other unless they are mutually exclusive.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A system comprising:
at least one memory device; and
at least one processor coupled with the memory device, the at least one processor configured to at least:
receive a series of images of a golf club captured during a golf swing;
detect from the series of images, using a machine learning model, one or more sticker labels placed on the golf club; and
classify, using the machine learning model, a golf club type of the golf club based on recognizing a marker coded on the one or more sticker labels, the marker for representing a specific type of golf club.

2. The system of claim 1, further including at least a camera coupled with the at least one processor, the camera configured to capture the series of images of the golf club during the golf swing.

3. The system of claim 1, wherein prior to using the machine learning model in detecting and classifying, the at least one processor is further configured to train the machine learning model using a plurality of images of golf clubs captured during a plurality of sessions of golf swings, as training data, to detect sticker labels placed on golf clubs and to classify golf club types based on recognizing markers assigned to different types of golf clubs coded on the sticker labels.

4. The system of claim 1, wherein the one or more sticker labels are detected from club head of the golf club.

5. The system of claim 1, wherein the one or more sticker labels are detected from golf shaft of the golf club.

6. The system of claim 1, wherein the marker includes a combination of symbols coded on the one or more sticker labels.

7. The system of claim 1, wherein the one or more sticker labels include retro-reflective material.

8. The system of claim 7, wherein the retro-reflective material includes fabric having micro glass beads as a retro-reflective element.

9. The system of claim 7, wherein the retro-reflective material includes paint having micro glass beads as a retro-reflective element.

10. The system of claim 1, wherein the one or more sticker labels are one or more of: vinyl stickers, vinyl stickers with laminate, polyester stickers, polypropylene stickers, synthetic paper stickers, laminated stickers, stickers with ultra-violet (UV) light resistant inks, permanent adhesives, heat-releasable stickers, see-through background stickers, or any combinations thereof.

11. The system of claim 1, wherein the at least one processor is further configured to use information of the golf club type with motion properties of the golf club in analyzing performance of the golf swing.

12. The system of claim 1, wherein the marker includes a pattern comprising two stripes and a gap separating the two stripes, each of the two stripes and the gap having a configured thickness, the type of the golf club being identified based on determining a cross-ratio using four image points defining thicknesses of the two stripes.

13. A system comprising:
at least one memory device; and
at least one processor coupled with the memory device, the at least one processor is configured to at least:
receive a series of images of a golf club captured during a golf swing;
detect from the series of images, one or more sticker labels placed on the golf club; and
identify a type of the golf club based on recognizing a marker coded on the one or more sticker labels, the marker for representing a specific type of golf club,
wherein the marker is coded with a pattern comprising two stripes and a gap separating the two stripes, each of the two stripes and the gap having a configured thickness, the type of the golf club being identified based on determining a cross-ratio using four image points defining thicknesses of the two stripes.

14. The system of claim 13, wherein thickness of the two stripes and the gap are divided into a specified number of bins, the pattern being formed based on the number of bins, into which the two stripes and the gap fall.

15. The system of claim 14, wherein the at least one processor is further configured to create a template that maps cross-ratios and golf club types based on using combinations of thicknesses of the two stripes and the gap corresponding to respective golf club types, wherein the cross-ratio is matched with one of the cross-ratios specified in the template in identifying the golf club type.

16. The system of claim 13, wherein the one or more sticker labels are detected from a shaft of the golf club.

17. A computer-implemented method comprising:
receiving a series of images of a golf club captured during a golf swing;
detecting from the series of images, by a machine learning model, one or more sticker labels placed on the golf club; and
classifying, by the machine learning model, a golf club type of the golf club based on recognizing a marker coded on the one or more sticker labels, the marker for representing a specific type of golf club.

18. The computer-implemented method of claim 17, further including:
capturing using a camera the series of images of the golf club during the golf swing.

19. The computer-implemented method of claim 17, further including:
prior to using the machine learning model in the detecting and the classifying, training the machine learning model using a plurality of images of golf clubs captured during a plurality of sessions of golf swings, as training data, to detect sticker labels placed on golf clubs and to classify golf club types based on recognizing markers assigned to different types of golf clubs coded on the sticker labels.

20. The computer-implemented method of claim 17, wherein the marker includes a pattern comprising two stripes and a gap separating the two stripes, each of the two stripes and the gap having a configured thickness, the type of the golf club being identified based on determining a cross-ratio using four image points defining thicknesses of the two stripes.

21. A computer readable storage medium storing a program of instructions executable by a machine to perform a method of:
receiving a series of images of a golf club captured during a golf swing;
detecting from the series of images, by a machine learning model, one or more sticker labels placed on the golf club; and
classifying, by the machine learning model, a golf club type of the golf club based on recognizing a marker coded on the one or more sticker labels, the marker for representing a specific type of golf club.

22. The computer readable storage medium of claim 21, wherein the marker includes a pattern comprising two stripes and a gap separating the two stripes, each of the two stripes and the gap having a configured thickness, the type of the golf club being identified based on determining a cross-ratio using four image points defining thicknesses of the two stripes.
